(19) United States
(12) Patent Application Publication
(10) Pub. No.: US 2008/0011656 A1
(43) Pub. Date: Jan. 17, 2008

(54) Shower filter apparatus

(76) Inventors: Jarvis Marcellus Lacy, Grand Prairie, TX (US); Hongqi Zhang, Tianjin (CN); Grace Deguia Lacy, Grand Prairie, TX (US)

Correspondence Address: Jarvis M. Lacy, 2707 Scarborough Drive, Grand Prairie, TX, 75052, US

(21) Appl. No.: 11/823,253

(22) Filed: Jun. 27, 2007

Related U.S. Application Data
(60) Provisional application No. 60/807,602, filed on Jul. 17, 2006.

(51) Int. Cl. B01D 35/30; B01D 21/30; B01D 29/00; B01D 35/14

(52) U.S. Cl. 210/95; 210/137; 210/232; 210/238

(57) ABSTRACT

A shower filter apparatus to neutralize chlorine and chloramines from water using water soluble vitamin c in the forms of ascorbic acid and sodium ascorbate, vitamin e in the form of tocopheryl acetate to prevent the oxidation of vitamin c, a cylindrical threaded replaceable sealed cartridge system with carefully sized media feed apertures to control delivery of said vitamin solution, a gasketed flow control device that creates a positive water tight seal over the media feed apertures when the device is not in use, a transparent observation window within the media cartridge.

### CROSS REFERENCE RELATED APPLICATIONS

This application is based on provisional application Ser. No. 60807602, filed on Jul. 17, 2006.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of water filters and more specifically to a shower filter apparatus to neutralizing chlorine and chloramine from water using water soluble vitamin c in the forms of ascorbic acid and sodium ascorbate.

Vitamin C dechlorination of water sources across various industries has a lengthy and well established history. It has been used in US EPA and APHA methods for the dechlorination of lab samples. In the medical industry, it is the standard for critical applications such as dialysis, where the introduction of chlorinated water or other toxic chemicals would be catastrophic. Breeders of rare fish also choose this method of dechlorination because of favorable side benefits associated with its use. Historically, Vitamin C dechlorination has been used in the treatment of chlorinated waste water prior to flushing back out into the environment, since it fully neutralizes both free chlorine and chloramines nearly instantaneously. There are several powerful arguments for using Vitamin C as a dechlorinating agent instead of KDF, activated carbon or various other sulfur-based compounds. Vitamin C utilizes powerful and near instantaneous ascorbic acid and sodium ascorbate chemistry to achieve complete dechlorination. It is made with a vitamin essential to humans and many animals, which is widely known to boost the immune system and improve overall health. It;s also the safest and least toxic of all known dechlorinating agents. Research by US EPA found that Vitamin C reacts rapidly and stoichiometrically with active chlorine and has limited interactions with disinfection byproducts. They found no interference from Vitamin C or its oxidation product (dehydroascorbic acid or dehydroascorbate) in mutagenicity assays of chlorinated NOM using Salmonella typhimurium TA100, with or without metabolic activation.

U.S. Pat. No. 3,695,450 discloses a water tap filter that connects to a water tap. This tap filter includes a filtration pad supported by a mesh screen held within. A mixer is installed after the filtration pad and mesh screen in order to aerate the water as it passes through the filter.

U.S. Pat. No. 3,760,951 discloses a water filter that inserts into a waterline by means of a quick disconnect fitting that allow the water filter to be quickly removed for maintenance or replacement.

U.S. Pat. No. 3,780,869 discloses a water filter that utilizes several compartments and multiple filtration elements housed within. This water filter includes two separate main body parts which are threaded together that allow the body to be disassembled and reassembled in order to clean the multiple filtration elements located inside. This water filter also includes a valve that allows the device to alternate between supplying filtered and unfiltered water.

U.S. Pat. No. 3,822,018 discloses a water filter that features two hemispherical sections joined together by threaded means. This water filter includes several filtration elements housed within and a valve that directs water through the filtration elements or by bypassing the filtration elements completely, allowing the water to flow unfiltered through the device.

U.S. Pat. No. 4,107,046 discloses a water purifier apparatus that allows, through the use of an internal valve, the direction of water through a filtration cartridge or through a path that bypasses the filtration cartridge completely. The filtration media used within this device is a combination of granulated carbon and silver zeolite sandwiched between several fibrous sheets of material, such as a felt.

U.S. Pat. No. 4,172,796 discloses a water faucet filtration device that allows the flow of water to be directed either through internal filtration elements or be discharged untreated. The filtration media used within this device consists of activated carbon or a combination of carbon and oligodynamic silver.

U.S. Pat. No. 4,244,526 discloses a shower head having flow control abilities through the use of a flow regulator house within. This shower head proposes to maintain a constant water flow rate through the use of said flow regulator.

U.S. Pat. No. 4,504,389 discloses a water faucet filtration device containing a removable cartridge or filtration element within and a valve for selecting whether the faucet provides filtered or unfiltered water. The internal filtration cartridge may be replaced by removing the cap covering a separate cartridge housing, removing the old cartridge and replacing it with a new one. The filtration media used within this device consists of various layers of polyethylene and activated carbon particles.

U.S. Pat. No. 4,642,192 discloses a free chlorine filtration media called KDF which operates on an electronegative cell potential that effectively binds and changes free chlorine into zinc chloride. The two elements of KDF are granulated copper and zinc metals.

U.S. Pat. Nos. 5,152,464 and 5,300,224 both disclose compact shower filter assemblies containing filtration media such as copper and zinc (KDF) to change free chlorine into zinc chloride.

U.S. Pat. Nos. 5,914,043 and 6,056,875 both disclose a method of filtering chlorine and chloramines from water using an internal bed of non soluble ceramic beads. These beads are comprised of a combination of a ceramic binder and calcium sulfite. This method uses a combination of calcium sulfite beads and KDF as the means to neutralize chlorine and certain chloramines found in water.

The shortcomings of using carbon and activated carbon within a shower filter apparatus can be attributed to the high flow rate and high temperature of the water. The effectiveness of carbon is directly proportional to the relatively low temperature of the water and the overall contact time with said water source. Neither of these conditions normally occurs in the average shower. Under these conditions, carbon's natural adsorptive qualities very quickly become nullified and simply become a food source for bacteria. The overall lifetime of carbon used within devices of this type is very short. Carbon type filters become clogged very quickly by sediment and other contaminants it is intended to remove from the water source. As soon as this occurs, any previously adsorbed contaminants are immediately released back into the water stream, thereby negating any benefits that may have been observed previously.

There are several limitations of using KDF media as a dechlorinator within a shower filter apparatus. KDF type filters are negatively affected by water pressure and water temperature. When water pressure is less than optimal, it simply cannot pass through the KDF media without adversely affecting the water pressure of the shower. The overall dechlorinating performance of KDF is directly related to the temperature of the water, where appreciable dechlorination simply does not occur below 84 degrees Fahrenheit. KDF is also significantly affected by the quality of water that it is exposed to. When the quality of the water is considered to be less than optimal or has a high sediment content, these impurities will eventually coat the surface of the KDF and nullify it's performance even further. Lastly, KDF is only capable of neutralizing free chlorine and can do nothing to reduce chloramines. This is quickly becoming a growing concern as the US EPA has mandated that all water municipalities are to switch to chloramine public water disinfection, as opposed to free chlorine, in the near future.

Sulfur based compounds, such as calcium sulfite or sodium sulfite (and sulfate) are indeed effective dechlorinating agents, however, chemicals of this type can be toxic to both humans and wildlife. An excess of sulfites and sulfates as always been of great concern to many environmental groups, including the US EPA.

There still remains a need within this industry for a safer and more environmentally conscious method of dechlorinating water used by the public. Vitamin C dechorination provides highly efficient dechlorination while meeting or exceeding the many safety regulations of local communities and federal agencies alike, such as the US EPA.

### BRIEF SUMMARY OF THE INVENTION

The primary object of the invention is to provide an improved shower filter apparatus to neutralize free chlorine and chloramines from water, which utilizes water soluble media in the forms of ascorbic acid and sodium ascorbate.

Another object of the invention is to provide an improved shower filter apparatus that attaches quickly and easily to all standard water supply pipes or fixtures and that does not require any tools for assembly or installation.

Another object of the invention is to provide an improved shower filer apparatus that features a cylindrical user replaceable cartridge that my be exchanged quickly and easily only when needed.

A further object of the invention is to provide an improved shower filter apparatus that utilizes vitamin e, in the form of tocopheryl acetate, to prevent the oxidation of the vitamin c, thereby increasing both the potency and longevity of the dechlorinating media contained therein.

Yet another object of the invention is to provide an improved shower filter apparatus that utilizes an flow control device that creates a positive seal against the media cartridge which prevents the water soluble vitamin solution from escaping the cartridge when the device is not in use, thereby increasing overall cartridge life.

Still yet another object of the invention is to provide an improved shower filter apparatus that features a bypass flow through design that isolates the water soluble media from the full volume of water through the use of media feed apertures to control the release of said media into the passing stream of water.

Another object of the invention is to provide an improved shower filter apparatus that utilizes non reactive, high quality plastics and rubberized gaskets in order to eliminate cracking or leaking.

Another object of the invention is to provide an improved shower filter apparatus that features a replaceable cartridge with a transparent window that allows users to determine the remaining life of each media cartridge by viewing the amount of vitamin crystals housed therein.

Other objects and advantages of the present invention will become apparent from the following descriptions, taken in connection with the accompanying drawings, wherein, by way of illustration and example, an embodiment of the present invention is disclosed.

Accordingly, it is a general object of the present invention to prove an improved shower filter apparatus. It is a particular object of the present invention to provide instantaneous dechlorination of both free chlorine and chloramines. It is a still more particular object of this invention to provide near perfect dechlorination of all currently known types of public water disinfectants in use in a manner that is safer and more environmentally conscious than methods being currently employed.

In accordance with one aspect of the invention, there is provided a shower filter apparatus that includes a unique bypass design that does not attempt to force the entire volume of water through the device, but instead, releases a controlled amount of dechlorinating media into an agitation chamber where it is thoroughly mixed with the water as it flows through the device before being allowed to exit. This provides a method of dechlorinating water that can provide a substantially extended service life, near perfect dechlorination results through of the use of vitamin c and exhibits none of the shortcomings of similar devices with respect to water pressure.

In accordance with another aspect of the invention, there is provided a shower filter apparatus that includes a unique controlled media release function through the use of carefully sized media feed apertures and a conical self-sealing flow control gasket that seals these apertures. This flow control gasket is intended to both isolate the media within the cartridge when water flow is not present and to help increase agitation between the dechlorinating media and water when in use. This provides for a maximum economy of media and eliminates waste due to the possible leeching of media solution while the device is idle.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention shown in its fully assembled state.

FIG. 2 is a side elevation view of the invention in its fully assembled state.

FIG. 3 is a side cross sectional view of the invention bisecting the unit precisely through its central plane.

FIG. 4 is an exploded elevation view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The following description is provided to enable any person skilled in the art to make and use the invention and sets forth the best method by the inventor of carrying out his invention. Various modifications will remain readily apparent to those skilled in the art, since the generic principles of the present invention have been previously defined to provide an improved shower filter apparatus.

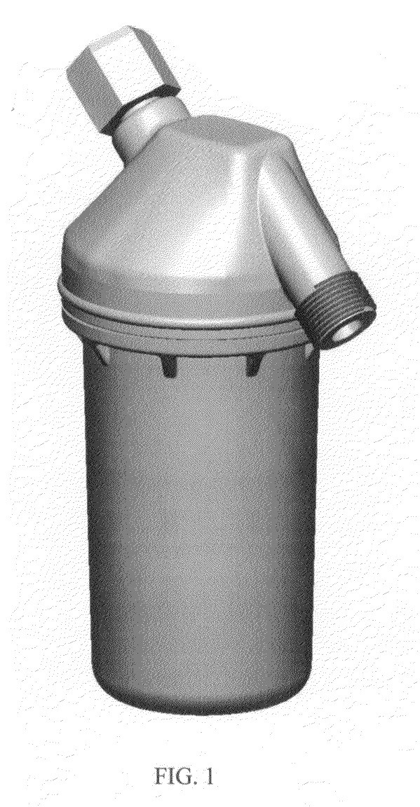

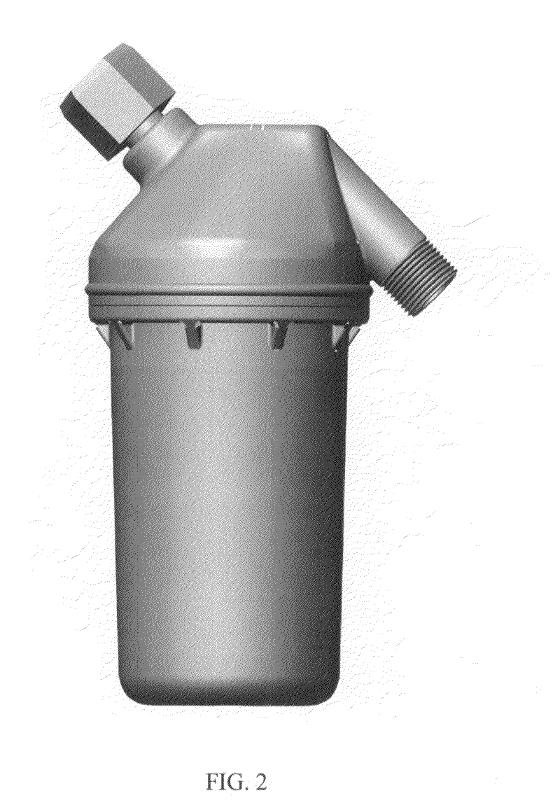

Turning now to the drawings, FIGS. 1 and 2 show the invention in its fully assembled state, with the media cartridge 28 securely attached to the main housing 24 above, through the use of mating threads. It will be readily apparent to those skilled in the art that the internally threaded hex swivel nut 23, with its accompanying swivel nut gasket 20, may be readily attached to the end of a shower arm or water supply pipe in the conventional manner. This hex swivel nut 23, in turn, is securely attached to the main body 24 of the device by means of an externally threaded hex screw 21 and hex screw gasket 22, which mates to corresponding internal threads found in the shoulder of the main body 24. The externally threaded outlet extension of the main body 24 protrudes from the main body a sufficient distance and contains the appropriate number and type of threads to allow the mounting of both standard shower heads and hand held fixtures.

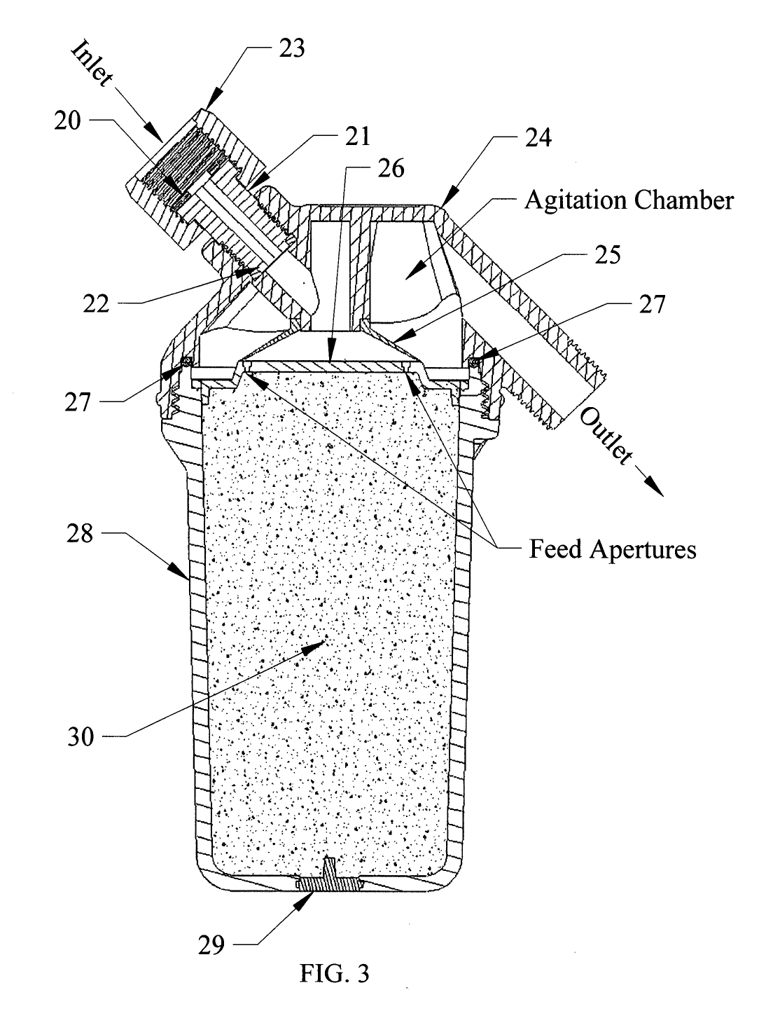

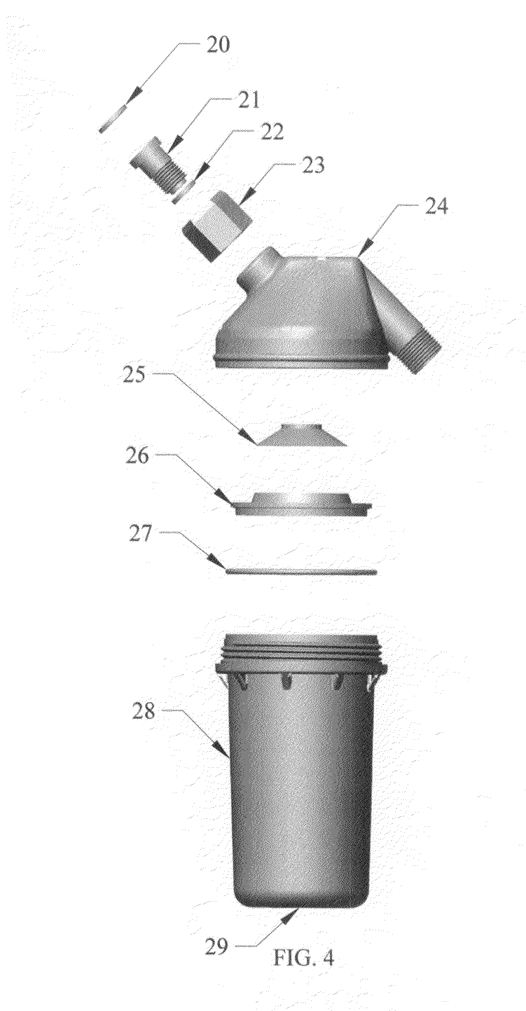

As shown in FIGS. 3 and 4, the media cartridge 28 is a hollow, cylindrical reinforced chamber filled with dechlorinating and antioxidant media 30. The preferred type of reinforcement is in the form of several radially arrayed gussets integrated into the main structure and spaced equally apart just below the base of the external threads found on the media cartridge 30. A rounded cartridge lid 26 is permanently adhered to the top of the media cartridge in order to achieve a water tight seal, although slightly recessed to create a lip. In order to standardize the height of this lip, a corresponding stop is built into the media cartridge 30 for the cartridge lid to securely rest on during permanent attachment, The preferred method of attachment is by way of ultrasonic plastic welding techniques, or alternately, a non reactive and odorless adhesive. The plurality of drilled media feed apertures are countersunk into the cartridge lid 26 a sufficient depth to ensure constant and even distribution of media into the agitation chamber above. A transparent observation window 29, is permanently mounted to the bottom of the media cartridge 28 to allow one to quickly check the amount of dechlorinating media 30 remaining within, thus providing an accurate and simple method of estimating the end of media cartridge 28 life. The externally threaded media cartridge 28 attaches to the internally threaded main housing 24 through the use of a mating thread design, which is sealed in place by a round, o-ring gasket 27 that is seated within a recess built into the main housing 24. When the media cartridge 28 and main housing 24 are fully engaged, the lip that was created once the cartridge lid 26 was attached to media cartridge 28 presses against the cartridge o-ring 27 to create a water tight seal between both halves of the device.

The media flow control gasket 25 is securely adhered to an interior surface of the main housing 24 through the use of a odorless, colorless and non reactive adhesive. With the media cartridge 28 fully engaged to the main housing 24, this flow control gasket presses down on the media cartridge lid 26 and effectively seals the media feed apertures through compression. This creates a water tight seal preventing oxygenated water from entering, or media solution from exiting, the media cartridge 28 through the feed apertures when the device is not in use to further help prevent oxidation and waste of the dechlorinating media 30 contained therein. As water begins to flow through the shower filter apparatus, the water pressure will force this flow control gasket 25 to break its seal over the media feed apertures and allow the media 30 to flow freely from the cartridge 28. This flow control gasket 25 also serves to increase agitation between the dechlorinating media and chlorinated water within the agitation chamber, thus creating highly favorable results by establishing an environment where complete dechlorination may be achieved.

Accordingly, as will those skilled in the art, the present invention provides considerable advantages in ease and flexibility of manufacture, installation, maintenance, durability and overall efficiency of design.

Those skilled in the art will appreciate the various adaptations and modifications of the just described preferred embodiment can be configured without departing from the scope and spirit of the invention. Therefore, it is to be understood that, within the scope of the appended claims, the invention may be practiced other than as specifically described herein.

While the invention has been described in connection with a preferred embodiment, it is not intended to limit the scope of the invention to the particular form set forth, but on the contrary, it is intended to cover such alternatives, modifications, and

What is claimed is:

1. A shower filter apparatus comprising:
of two primary sub-assemblies, when assembled through the use of mating threads, constitute a complete working shower filter apparatus;
a main housing assembly containing a hollow agitation chamber therein with inlet and outlet means connected thereto to allow the flow of water into and out of said chamber;
a substantially sealed cylindrical hollow cartridge containing dechlorinating and antioxidant media therein;

2. A shower filter apparatus of claim 1 further comprising water inlet means by way of an internally threaded swivel hex nut that attaches directly to a water supply line;

3. A shower filter apparatus of claim 1 further comprising water outlet means by way of an externally threaded extension intended to accept both standard shower heads and hand held fixtures;

4. A shower filter apparatus of claim 1 further comprising a substantially conical flow control gasket securely mounted to an interior surface of the agitation chamber within the main housing for the purpose of regulating the output flow of dechlorinating media and to prevent oxygen from entering the media cartridge;

5. A shower filter apparatus of claim 1 further comprising a circular o-ring gasket mounted within a recess found in the main housing to create a water tight seal between both halves of the apparatus once assembled;

6. A shower filter apparatus of claim 1 further comprising dechlorinating media of ascorbic acid;

7. A shower filter apparatus of claim 1 further comprising dechlorinating media of sodium ascorbate (vitamin c);

8. A shower filter apparatus of claim 1 further comprising antioxidant media of tocopheryl acetate (vitamin e);

9. A shower filter apparatus of claim 1 further comprising a flat circular gasket present at the threaded swivel hex nut to provide a water tight seal at the water supply line connection point;

10. A shower filter apparatus of claim 1 further comprising a media cartridge lid with a plurality of feed apertures of varying diameter to allow the controlled release of dechlorinating and antioxidant media into the agitation chamber above;

11. A shower filter apparatus of claim 1 further comprising a conical flow control gasket of sufficient diameter to seal the plurality of media feed apertures present in the media cartridge lid;

12. A shower filter apparatus of claim 1 further comprising a conical flow control gasket for the purpose of sealing the plurality of feed apertures in the media cartridge lid whenever water flow ceases;

13. A shower filter apparatus of claim 1 further comprising a conical flow control gasket intended to create agitation of the water and thereby improve contact time with said dechlorinating media;

14. A shower filter apparatus of claim 1 further comprising a flat, circular gasket internally mounted to allow the shower filter apparatus to be rotated 360 degrees after installation;

15. A shower filter apparatus of claim 1 further comprising a transparent window at the bottom of the media cartridge to allow for a visual check of estimated remaining cartridge life by noting the presence and amount of vitamin crystals housed therein;
